(19) United States
(12) Patent Application Publication
(10) Pub. No.: US 2006/0269583 A1
(43) Pub. Date: Nov. 30, 2006

(54) Process and composition for treating wood

(76) Inventors: Carey F. Garst, Boones Mill, VA (US); Amelia L. DaCruz, Virginia Beach, VA (US)

Correspondence Address: MORGAN LEWIS & BOCKIUS LLP, 1111 PENNSYLVANIA AVENUE NW, WASHINGTON, DC, 20004, US

(21) Appl. No.: 11/434,758

(22) Filed: May 17, 2006

Related U.S. Application Data
(60) Provisional application No. 60/685,385, filed on May 31, 2005.

(51) Int. Cl. A01N 25/00; A01N 59/06; B32B 21/02; B32B 21/10

(52) U.S. Cl. 424/405; 424/684; 428/292.4

(57) ABSTRACT

The invention relates to a method for reducing the rate of deterioration of wood by providing an aqueous wood preservative composition having dissolved aluminum and dissolved and/or suspended silica, in which the concentration of aluminum as alumina is between about 300 mg Al₂O₃/L and 20000 mg Al₂O₃/L and the concentration of aluminum as alumina is at least two times the concentration of silica, and injecting the aqueous wood preservative composition into wood. Advantageously, the pH of the injected wood preservative composition is below about 3. Such a formulation is an effective wood preservative that is free of environmentally sensitive compounds such as copper, organic insecticides, and the like. However, such environmentally sensitive compounds can be used with the process of this invention, in some cases to bolster the biocidal effect.

### RELATED APPLICATIONS

This application is based on U.S. Provisional 60/685,385, filed May 31, 2005.

### STATEMENT REGARDING FEDERALLY SPONSORED RESEARCH OR DEVELOPMENT

Not Applicable.

### FIELD OF THE INVENTION

The invention relates to compositions and methods for improved wood preservation by the preparation and use of a biocidally effective aqueous composition comprising dissolved silica and alumina.

### BACKGROUND OF THE INVENTION

The production of wood which has been treated to inhibit biological decomposition is well known. Decay is caused by fungi and insects that feed on cellulose or lignin of wood. Exemplary fungi causing wood decomposition include: basidiomycetes such as Gloeophyllum trabeum (brown rot), Trametes versicolor (white rot), Serpula lacrymans (dry rot) and Coniophora puteana. Exemplary organisms causing wood decomposition include coleopterans such as Anobium punctatum (furniture beetle), Hylotrupes bajulus (house longhorn) and Xestobium rufovillorum (death watch beetle); hyrnenopterans such as termites and carpenter ants; and also by marine borers and/or wasps. Finally, termites are ubiquitous, and termite damage is estimated in the United States alone to be about $2 billion per year

The production of wood based composite products has increased dramatically in recent years. Oriented strandboard (OSB) production exceeded that of plywood in 2000. The use of medium density fiberboard and hardboard panel products likewise has increased dramatically over the last couple decades. However, these products are typically used in interior applications where attack from insects or decay fungi is limited, because it has been found that these products are particularly susceptible to attack by biological agents such as decay fungi and termites.

Preservatives are used to treat wood to resist insect attack and decay. The commercially used preservatives are separated into three basic categories, based primarily on the mode of application, into waterborne, creosote, and oil borne preservatives. Waterborne preservatives include chromated copper arsenate (CCA), ammoniacal copper quat, ammoniacal copper zinc arsenate, and ammoniacal copper arsenate. Wood treated with these chemicals sometimes turn green or grey-green because of a chemical reaction between copper in the preservative and the sun's ultraviolet rays. The preservatives leach into the soil over time, especially those made without chromium, when exposed to weather.

Modern organic biocides are considered to be relatively environmentally benign and not expected to pose the problems associated with CCA-treated lumber. Biocides such as tebuconazole are quite soluble in common organic solvents while others such as chlorothalonil possess only low solubility. The solubility of organic biocides affects the markets for which the biocide-treated wood products are appropriate. Biocides with good solubility can be dissolved at high concentrations in a small amount of organic solvents, and that solution can be dispersed in water with appropriate emulsifiers to produce an aqueous emulsion. The emulsion can be used in conventional pressure treatments for lumber and wood treated in such a manner can be used in products such as decking where the treated wood will come into contact with humans. Biocides which possess low solubility must be incorporated into wood in a solution of a hydrocarbon oil such as AWPA P9 Type A and the resulting organic solution used to treat wood directly.

The primary preserved wood product has historically been southern pine lumber treated with chromated copper arsenate (CCA). Most of this treated lumber was used for decks, fencing and landscape timbers. There has recently been raised concerns about the safety and health effects of CCA as a wood preservative, primarily relating to the arsenic content but also to the chromium content. In 2003/2004, due in part to regulatory guidelines and to concerns about safety, there has been a substantial cessation of use of CCA-treated products. A new generation of copper containing wood preservatives use a form of copper that is soluble. Known preservatives include copper alkanolamine complexes, copper polyaspartic acid complex, alkaline copper quaternary, copper azole, copper boron azole, copper bis(dimethyldithiocarbamate), ammoniacal copper citrate, copper citrate, and the copper ethanolamine carbonate. In practice the principal criteria for commercial acceptance, assuming treatment efficacy, is cost. Of the many compositions listed above, only two soluble copper containing wood preservatives have found commercial acceptance: 1) the copper ethanolamine carbonate manufactured for example according to the process disclosed in U.S. Pat. No. 6,646,147; and copper boron azole. There are, however, several problems with these new copper-containing preservatives.

The soluble copper containing wood preservatives are very leachable, compared to CCA. One study has shown that as much as 80 percent of the copper from a copper amine carbonate complex is removed in about 10 years under a given set of field conditions. This leaching is of concern for at least two reasons: 1) removal of the copper portion of the pesticide from the wood by leaching will compromise the long term efficacy of the formulation, and 2) the leached copper causes concern that the environment will be contaminated. While most animals tolerate copper, copper is extremely toxic to certain fish at sub-part per million levels. Copper leaching is such a problem that some states do not allow use of wood treated with the soluble copper containing wood preservatives near waterways.

Another concern with soluble copper preservative products generally is that most preservative materials are manufactured at one of several central locations but are used in disparate areas and must be shipped, sometimes substantial distances. The cost of providing and transporting the liquid carrier for these soluble products can be considerable, and the likelihood of an extreme biological impact is very high if transported soluble copper wood preservative material is spilled or accidentally released near a waterway.

Further, unlike CCA, all of these soluble copper containing wood preservatives require a second organic biocide to be effective against some biological species. Therefore, wood preserved with these soluble copper containing wood preservatives also contain a second biocide that is efficacious against one or more particularly troublesome species. Oil-soluble biocides such as a copper(II)-sulfited tannin extract complex (epicatechins) can be dissolved in light oils, emulsified in water, and injected into the wood, as is disclosed in U.S. Pat. No. 4,988,545. Alternatively, the second biocide is often slightly water soluble or be emulsified, and may be composed of a triazole group or a quaternary amine group or a nitroso-amine group, and this biocide can be simply added to the fluid used for pressure treating the wood. None of these have found commercial acceptance.

U.S. Pat. No. 6,579,354 describes a water soluble acidic copper pesticide combined with aluminum nitrate wherein the weight ratio of aluminum nitrate to copper ranges from 1 to 10 to 10 to 1. This patent describes making the wood preservatives by dissolving aluminum nitrate in water (typically with a small amount of nitric acid), contacting the solution with a copper salt (preferably copper hydroxide), and then adding acid until the copper salt is dissolved. The patent states that both inorganic and organic salt of the copper can be prepared by reacting an acid with copper metal, copper oxide, copper carbonate, or copper hydroxide. The patent teaches that copper salts of the stronger acids are more water soluble, and more difficult to fix in the wood. Problems with this method is that aluminum nitrate is comparable in cost to basic copper carbonate, e.g., between $1.20 and $2.00 per kilogram. Cost is the most important criteria for wood preservation. Additionally, the composition comprises copper. Also, bulk aluminum nitrate can be hazardous unless kept in an aqueous solution. Finally, U.S. Pat. No. 6,579,354 describes treating wood with an alkali silicate solution and an alkali borate solution to form a borate-silicate polymer within the wood. The use of two sequential treatments is not acceptable to the industry.

U.S. Pat. No. 3,974,318 discloses a process whereby water soluble silicate compositions are applied to a wood product, and the product is subsequently treated with a water soluble metallic salt compound to form a water insoluble metallic silicate in the wood product. Improvements on this method have been disclosed in U.S. Pat. No. 6,235,349, and U.S. Pat. No. 5,478,598, and U.S. Pat. No. 6,146,766. U.S. Pat. No. 6,146,766 has an example wherein wood was first pressure impregnated with an aqueous solution of sodium silicate, then dried, and subsequently was pressure impregnated with a second solution. It is unclear whether the first solution contained silicate and the second solution contained aluminum hydroxide, or whether both solutions contained both aluminum hydroxide and sodium silicate components. The use of two sequential treatments is not acceptable to the industry, and the cost of the chemicals used is very high. Additionally, the amount of aluminum present in a saturated solution of aluminum hydroxide would be so low as to be negligible (less than 1 ppm), as the Ksp of aluminum hydroxide is about 10⁻³³, so about 10⁻⁸ moles of aluminum would be expected in a liter of water.

Published US Application No 2004/0166246 describes a composition that is an aqueous colloidal silicon-containing salt that is supersaturated with a boron-containing salt and optionally includes an aluminum salt and a preservative, which is useful for reducing the rate of deterioration of wood. The composition must be alkaline, must contain colloidal silicon, and must be supersaturated with a boron-containing salt. The composition may have 1% silicate and less that 1% of an aluminum salt. The composition is made by mixing the boron-containing salt with a colloidal, aqueous mixture of a silicon-containing salt and optionally adding the aluminum salt and the preservative. The process is performed under conditions that result in a supersaturated solution of the boron-containing salt. Wood treated with the composition appears to be resistant to insects, rot, UV deterioration, fire, and other environmental insults.

U.S. Pat. No. 6,653,324 describes a top coat wood stabilizer that may contain a soluble dye and/or a pigment and/or a filler. The pigment may be an organic, inorganic or metallic pigment. The pigments may be opaque or transparent such as for example transparent iron oxides. The filler may be typically kaolin, calcium carbonate or aluminium silicate. Preferably the top coat is a clear varnish, i.e. it contains no undissolved components.

Its known to use thickening compound which could be an organic compound such as polysaccharide biopolymers, polyacrylic acids, xanthan gum, locust bean gum, guar gum, carrageenan, alginic acid and its salts, and tragacanth gum, or an inorganic fine powder such as aluminum magnesium silicate, bentonite (Al₂O₃ 4SiO₂H₂O) and synthetic hydrated silicone dioxide. U.S. Pat. No. 5,693,644 describes a method for controlling wood rotting fungi comprising applying a composition comprising a pyridylpyrimidine compound in an oil-based formulation. As the thixotropy-imparting compound, there is used, for example, bentonite, aluminium magnesium silicate, xanthane gum, polyacrylic acid, or the like. Similarly, U.S. Pat. No. 5,332,427 describes a wood preservative comprising a styryl triazole derivative that resists discoloration under exposure to light. The flowable formulation (an in-water suspension or an in-water emulsion) is generally obtained by micro-dispersing 1-75% of the styryl triazole derivative in water containing 0.5-15% of a dispersing agent, and 0.1-10% by weight of a suspension adjuvant (a protective colloid and a thixotropy-imparting compound). As the thixotropy-imparting compound, there is used, for example, bentonite, aluminium magnesium silicate, xanthane gum, polyacrylic acid, or the like.

The problems with current systems are: they add undesired oil; they increase corrosion; they are dilute; they are expensive, especially when the metal-based biocides must be combined with large quantities of organic biocides; the high copper leach rates are both a serious environmental problem in itself and it will almost certainly decrease the longevity of treatment below that obtained with CCA. However, cost is a primary factor in the selection of a wood preservative.

What is needed is a low cost wood preservative system that has low (or no) copper (nor other biocidal metal ion) leaching, has adequate longevity, has only minor effects on the paintability, and does not increase the corrosion aspects of the wood. The invention provides such a system.

### SUMMARY OF THE INVENTION

One aspect of this invention is a process and a composition for reducing the rate of deterioration of wood in a cost-effective manner. A second aspect of this invention is a process and a composition for reducing the rate of deterioration of wood with reduced (as opposed to prior art CCA and soluble copper-amine wood preservative treatments discussed above) or no leaching rate of various metals, including especially environmentally harmful metals such as copper, chromium, arsenic, and lead, but also including in certain embodiments even relatively benign biocidal metals such as zinc, tin, nickel, and the like. Yet another aspect of this invention is a process and a composition for reducing the rate of deterioration of wood, wherein the treated wood has low (as opposed to prior soluble copper-amine wood preservative treatments discussed above) corrosivity to metal. Yet another aspect of this invention is providing water repellancy to wood. Yet another aspect of this invention is providing fire retarding properties to the wood. Yet another aspect of this invention is a process and a composition for reducing the rate of deterioration of wood which is advantageously used in combination with one or more organic biocides. Yet another aspect of this invention is a process and a composition for reducing the rate of deterioration of wood which is advantageously used in combination with one or more metal-containing biocides. These various aspects, or sub-sets thereof, are met by the various embodiments of the invention described herein.

In all embodiments described herein, the concentration of the dissolved/suspended aluminum is, unless otherwise stated, specified as the concentration of alumina, though it is likely that some or most of the aluminum is in the form of soluble aluminum ions and/or aluminates. To convert mg Al/L to mg Al₂O₃/L, multiply by 1.89. If a composition comprises “300 mg/L aluminum (as Al₂O₃)” or alternatively “300 mg Al₂O₃/L”, this means the composition comprises about 159 mg aluminum per liter. In all embodiments described herein, the concentration of the dissolved/suspended silicon is specified as the concentration of silica, though it is possible that some or most of the silicon is in the form of silicates, colloidal silica, or silica salts. Silica from silicone oil does not contribute to the dissolved/suspended silicon. In all embodiments described herein, the concentration of titanium is specified as the concentration of titania (TiO₂), though it is possible that some or most of the titanium is in the form of titanates, other titanium oxides, soluble titanium salts, or the like. In all embodiments described herein, the concentration of iron is specified as the concentration of Fe₂O₃, though it is very likely that most of the iron is in the form of soluble iron salts. In all embodiments described herein, percent is weight percent and parts is parts by weight.

It is recognized that various components of the compositions of this invention interact, and therefore any composition is expressed as the amount of various components which, when added together, form the composition. Unless specifically stated, any composition given in percent is percent by weight of that component that has been added to the composition. When the composition is described as being substantially free of a particular component, generally there are numeric ranges provided to guide on of ordinary skill in the art to what is meant by “substantially free,” but in all cases where a composition is “substantially free” in the context of a biocidal ingredient encompasses any amount less than a biocidally effective amount (in that composition), and in all cases “substantially free” encompasses the preferred embodiment where the composition is totally free of that particular component.

The invention is generally discussed herein as a method of preserving wood comprising 1) providing an aqueous wood preservative composition, and 2) contacting or injecting the aqueous wood preservative composition into wood, where the wood preservative composition protects against one or more of fungal decay, termites and other insects, marine borers. Advantageously the wood preservative composition further acts as a sealant to protect wood from the natural effects of the environment such as rain and sun and inhibits warping, splitting, checking, and discoloration, and in some embodiments imparts to the treated wood a fire retardant which inhibits the spread of fire. The invention also encompasses the preservative compositions, as well as wood products that have been preserved with a composition of this invention.

Use of the term “aluminum” in the context of a liquid composition in preferred embodiments means “dissolved aluminum.” Advantageously, at least just prior to injection into the wood, at least one half, preferably at least three quarters, more preferably substantially all (>90%) of the aluminum is dissolved, as opposed to being present in the form of suspended particles of alumina or in the form of an alumina-silicate. Generally, to have the aluminum be dissolved requires a strongly acidic composition, e.g., the pH must be below about 3, preferably below about 2, typically below about 1, depending primarily on the aluminum concentration and to a lesser degree on other factors. We believe that suspended alumina particles, and even soluble aluminum silicates, may increase the longevity of the preservative treatment but otherwise are not efficacious compared to dissolved alumina which is subsequently precipitated. Dissolved aluminum can be distinguished from suspended thixotropic agents such as magnesium aluminum by for example raising the pH to 7 or higher with an alkali hydroxide, at which point dissolved aluminum will in less than 6 hours precipitate out as aluminum hydroxides and/or oxides. Alumina-silicates, on the other hand, can still be solubilized at that pH. Other methods of identifying dissolved aluminum as opposed to suspended particles and alumina-silicates may be used.

One embodiment of the invention is a process comprising injecting into wood an aqueous composition comprising or consisting essentially of dissolved/suspended alumina and dissolved/suspended silica, and optionally one or more co-biocides selected from a biocidally effective amount of a substantially insoluble organic biocide, a biocidally effective amount of biocidal copper, zinc, nickel, and/or tin salts and/or oxides, or both. In one embodiment the composition is substantially free of substantially insoluble organic biocides. In one embodiment the composition is substantially free of biocidal copper, zinc, nickel, and/or tin salts and/or oxides. In one preferred embodiment the composition is substantially free of biocidal copper salts and/or oxides. Advantageously the composition comprises more alumina than silica. Advantageously the concentration of dissolved aluminum (as alumina) is at least 1.5 times, preferably at least 2 times, more preferably at least 3 times, for example between about 4 times and 25 times the amount of dissolved/suspended silicon as silica. The composition may comprise between 1.5 times to about 30 times, alternately between about 2 time to about 16 times as much dissolved/suspended aluminum (as Al₂O₃) as dissolved/suspended silicon (as SiO₂). Alternatively, the weight of aluminum (as alumina) is at least two times, preferably at least 3 times, for example between about 5 times and about 25 times, alternately between about 4 times and about 14 times, the weight of silicon (as silica) in the aqueous composition. Advantageously, the amount of dissolved/suspended aluminum is between about 300 mg Al₂O₃/L and 20000 mg Al₂O₃/L, for example between about 500 mg Al₂O₃/L and 5000 mg Al₂O₃/L. Advantageously, the amount of dissolved/suspended silicon is between 10 mg SiO₂/L and 6000 mg SiO₂/L, for example between about 20 mg SiO₂/L and 2000 mg SiO₂/L. The weight ratio between dissolved/suspended alumina and dissolved/suspended silica may be between about 2:1 to about 50:1, for example between about 5:1 and 25:1. In preferred embodiments the composition at the time of injection is acidic, e.g., comprising between about 0.01 moles to about 12 moles of acid per liter, for example between about 0.1 moles to about 6 moles per liter of acid. The above wood preservative composition may advantageously further comprise dissolved/suspended iron, dissolved/suspended titania, or both. Advantageously, the amount of dissolved/suspended titanium is between 1 mg TiO₂/L and 2000 mg TiO₂/L, for example between about 10 mg TiO₂/L and 500 mg TiO₂/L. Advantageously, the amount of dissolved/suspended iron is between about 50 mg Fe₂O₃/L and 20000 mg Fe₂O₃/L, for example between about 100 mg Fe₂O₃/L and 5000 mg Fe₂O₃/L. Advantageously the composition comprises more alumina than titania. For example, the weight ratio between dissolved/suspended alumina and dissolved/suspended titania maybe between about 2:1 to about 500:1, for example between about 10:1 and 200:1. Advantageously the composition comprises more alumina than iron (as Fe₂O₃). For example, the weight ratio between dissolved/suspended alumina and dissolved/suspended iron (as Fe₂O₃) may be between about 1.1:1 to about 10:1, for example between about 1.5:1 and 3:1

It is not clear at this point whether the biocidal activity is provided from the aluminum/alumina, silicon/silica, iron, titanium/titania, or some combination thereof. We suspect that the observed biocidal activity is the result of the combination of at least two precipitated dissolution products of strong acid with alumina, silica, iron, and titania, where the most likely required components are at least two of the precipitated dissolution product of strong acid with alumina, silica, iron, and titania.

In an alternate embodiment, the process comprises injecting into wood an aqueous composition comprising or consisting essentially of dissolved/suspended alumina and dissolved/suspended titania, and optionally one or more co-biocides selected from a biocidally effective amount of a substantially insoluble organic biocide, a biocidally effective amount of biocidal copper, zinc, nickel, and/or tin salts and/or oxides, or both. In one embodiment the composition is substantially free of substantially insoluble organic biocides. In one embodiment the composition is substantially free of biocidal copper, zinc, nickel, and/or tin salts and/or oxides. In one preferred embodiment the composition is substantially free of biocidal copper salts and/or oxides. Advantageously, the amount of dissolved/suspended titanium is between 1 mg TiO₂/L and 2000 mg TiO₂/L, for example between about 10 mg TiO₂/L and 500 mg TiO₂/L. Advantageously, the amount of dissolved/suspended aluminum is between about 300 mg Al₂O₃/L and 20000 mg Al₂O₃/L, for example between about 500 mg Al₂O₃/L and 5000 mg Al₂O₃/L. Advantageously the composition comprises more alumina than titania. For example, the weight ratio between dissolved/suspended alumina and dissolved/suspended titania may be between about 2:1 to about 500:1, for example between about 10:1 and 200:1. In preferred embodiments the composition at the time of injection is acidic, e.g., comprising between about 0.01 moles to about 12 moles of acid per liter, for example between about 0.1 moles to about 6 moles per liter of acid. In one embodiment, the composition may further comprise iron. Advantageously, the amount of dissolved/suspended iron is between about 50 mg Fe₂O₃/L and 20000 mg Fe₂O₃/L, for example between about 100 mg Fe₂O₃/L and 5000 mg Fe₂O₃/L.

In another alternate embodiment, the process comprises injecting into wood an aqueous composition comprising or consisting essentially of dissolved/suspended silica and dissolved/suspended titania, and optionally one or more co-biocides selected from a biocidally effective amount of a substantially insoluble organic biocide, a biocidally effective amount of biocidal copper, zinc, nickel, and/or tin salts and/or oxides, or both. In one embodiment the composition is substantially free of substantially insoluble organic biocides. In one embodiment the composition is substantially free of biocidal copper, zinc, nickel, and/or tin salts and/or oxides. In one preferred embodiment the composition is substantially free of biocidal copper salts and/or oxides. Advantageously, the amount of dissolved/suspended silicon is between 10 mg SiO₂/L and 6000 mg SiO₂/L, for example between about 20 mg SiO₂/L and 2000 mg SiO₂/L. Advantageously, the amount of dissolved/suspended titanium is between 1 mg TiO₂/L and 2000 mg TiO₂/L, for example between about 10 mg TiO₂/L and 500 mg TiO₂/L. Advantageously the weight ratio between dissolved/suspended silica and dissolved/suspended titania is between about 1:1 to about 50:1, for example between about 1:5 and 1:25. The composition may advantageously further comprise iron. In one embodiment, the composition may further comprise aluminum, iron, or both. In preferred embodiments the composition at the time of injection is acidic, e.g., comprising between about 0.01 moles to about 12 moles of acid per liter, for example between about 0.1 moles to about 6 moles per liter of acid. In one embodiment, the composition may further comprise iron. Advantageously, the amount of dissolved/suspended iron is between about 50 mg Fe₂O₃/L and 20000 mg Fe₂O₃/L, for example between about 100 mg Fe₂O₃/L and 5000 mg Fe₂O₃/L.

In another embodiment, the process comprises injecting into wood an aqueous composition comprising or consisting essentially of dissolved/suspended silica, dissolved/suspended alumina, dissolved/suspended titania, and optionally one or more co-biocides selected from a biocidally effective amount of a substantially insoluble organic biocide, a biocidally effective amount of biocidal copper, zinc, nickel, and/or tin salts and/or oxides, or both. In one embodiment the composition is substantially free of substantially insoluble organic biocides. In one embodiment the composition is substantially free of biocidal copper, zinc, nickel, and/or tin salts and/or oxides. In one preferred embodiment the composition is substantially free of biocidal copper salts and/or oxides. Advantageously, the amount of dissolved/suspended silicon is between 20 mg SiO₂/L and 6000 mg SiO₂/L, for example between about 40 mg SiO₂/L and 2000 mg SiO₂/L. Advantageously, the amount of dissolved/suspended titanium is between 1 mg TiO₂/L and 2000 mg TiO₂/L, for example between about 10 mg TiO₂/L and 500 mg TiO₂/L. Advantageously, the amount of dissolved/suspended aluminum is between about 50 mg Al₂O₃/L and 20000 mg Al₂O₃/L, for example between about 400 mg Al₂O₃/L and 5000 mg Al₂O₃/L. Advantageously the weight ratio between dissolved/suspended silica and dissolved/suspended titania is between about 1:1 to about 50:1, for example between about 1:5 and 1:25. The composition may advantageously further comprise iron. The composition may advantageously further comprise dissolved/suspended alumina. Advantageously the composition comprises more alumina than silica. In preferred embodiments the composition at the time of injection is acidic, e.g., comprising between about 0.01 moles to about 12 moles of acid per liter, for example between about 0.1 moles to about 6 moles per liter of acid.

In another embodiment, the process comprises injecting into wood an aqueous solution comprising or consisting essentially of a) dissolved aluminum, b) silicon, c) optionally titanium, d) optionally iron, and e) optionally one or more co-biocides selected from i) a biocidally effective amount of a substantially insoluble organic biocide, ii) a biocidally effective amount of biocidal copper, zinc, nickel, and/or tin salts and/or oxides, or both. In one embodiment the composition is substantially free of substantially insoluble organic biocides. In one embodiment the composition is substantially free of biocidal copper, zinc, nickel, and/or tin salts and/or oxides. In one preferred embodiment the composition is substantially free of biocidal copper salts and/or oxides. The composition advantageously comprises between 1.5 and 40 moles of aluminum per mole of silicon. Alternately, the composition comprises at least 2 times, preferably at least 3 times, for example between about 4 times or 5 times and about 20 times, alternately between about 4 times or 5 times and about 14 times, the weight of aluminum (as Al₂O₃) compared to the weight of silicon (as silica) in the aqueous composition. The composition may further comprise aluminosilicates. Advantageously, the amount of dissolved silicon is between 10 mg SiO₂/L and 6000 mg SiO₂/L, for example between about 20 mg SiO₂/L and 2000 mg SiO₂/L. Advantageously, the amount of dissolved aluminum is between about 300 mg Al₂O₃/L and 20000 mg Al₂O₃/L, for example between about 500 mg Al₂O₃/L and 5000 mg Al₂O₃/L. Advantageously the composition comprises more alumina than silica. For example, the weight ratio between dissolved alumina and dissolved silica may be between about 2:1 to about 50:1, for example between about 5:1 and 25:1. In preferred embodiments the composition at the time of injection is acidic, e.g., comprising between about 0.01 moles to about 12 moles of acid per liter, for example between about 0.1 moles to about 6 moles per liter of acid.

In any of the above embodiments, the process may further comprise adding a base to the preservative composition prior to injecting the composition into the wood. Use of highly acidic compositions is not particularly preferred from a standpoint of safety, and further highly acidic compositions can slightly weaken the wood. At the same time, concentrated highly acidic compositions tend to be stable, and there is less risk that dilution with alkaline water will result in a pH above 2 where premature precipitation of alumina and/or aluminum hydroxide can result. We believe that above pH 2 or 2.5 aluminum ions in the aqueous composition will begin to precipitate. If the amount of base added is sufficient to raise the pH of the preservative composition above about 2, then advantageously the base is added within 30 minutes, preferably within 5 minutes, for example within 2 minutes, of injecting the composition into wood. A preferred wood preservative composition will have sufficient acid such that after the desired dilution with water the resulting pH will be between 0.5 and 2, for example between 1 and 1.8.

In any of the above embodiments, the composition may comprise colloidal particles, for example colloidal silica, colloidal alumina, colloidal titania, or mixture thereof. If so, advantageously, more than 99% by weight of all colloidal particles have an average diameter of less than 1 micron. We believe, however, that colloidal alumina has limited bio-efficacy. In any of the above embodiments, the wood preservative composition may be substantially free of colloidal particles just prior to being injected into the wood.

In any of the above embodiments, the wood preservative composition may comprise soluble borates. In any of the above embodiments, the wood preservative composition may be substantially free of borates, e.g., less than 0.5% based on the dried weight of the wood preservative composition.

In any of the above embodiments, the composition may comprise one or more co-biocides selected from substantially insoluble organic biocides, biocidal copper, zinc, nickel, and/or tin salts and/or oxides, or both. Advantageously, many of the biocidal metal salts are soluble enough to provide a biocidally effective amount of metal salt in the acidic compositions that comprise the most preferred embodiments of this invention. For organic co-biocides that are not soluble in the injected composition, advantageously these co-biocides are emulsified with a sufficient amount of dispersant, and the emulsion is then admixed with the wood preservative composition. For co-biocides that are not soluble in the injected composition and are not emulsified, advantageously these co-biocides are suspended in the preservative composition with a sufficient amount of dispersant. In any of the above embodiments, the wood preservative composition may be substantially free of biocidal copper, zinc, nickel, and/or tin salts and/or oxides, e.g., less than 0.5% based on the dried weight of the wood preservative composition. In any of the above embodiments, the wood preservative composition may be substantially free of biocidal copper salts and/or oxides, e.g., less than 0.1% based on the dried weight of the wood preservative composition. In any of the above embodiments, the wood preservative composition may be substantially free of substantially insoluble organic biocides, e.g., less than 0.1% based on the dried weight of the wood preservative composition.

In any of the above embodiments, the wood preservative composition is advantageously prepared by:

A) contacting a solid source of alumina (Al₂O₃) and silica (SiO₂) and also optionally iron and titanium with an aqueous strongly acidic composition for a time and at a temperature sufficient to dissolve/suspend the alumina and silica, wherein there is advantageously an excess of the source(s) of alumina and silica so that there remains solid source material after the dissolution/suspension, to form a wood preservative concentrate having a pH less than 2;

B) optionally, separating the aqueous strongly acidic composition from the remaining solid source after the dissolution/suspension;

C) optionally adding one or more organic biocides, one or more metal-containing biocides, or both, in a form wherein the resulting composition is a solution, a slurry, an emulsion, or some combination thereof;

D) optionally, diluting the aqueous composition with water, wherein the dilution is by a factor of between 1:0.1 to about 1:50 of parts (by weight) of the preservative composition to parts (by weight) of dilution water, where the pH of the resulting wood treatment composition is advantageously less than 2;

E) optionally adding base to adjust the pH to a value between about 0 and about 6.5, for example between about 1 to less than 3, alternately between about 1.5 and about 2.

Wood is preserved by contacting, preferably by injecting, the liquid composition obtained above into wood, and then by drying at least a portion of the liquid from the wood, thereby depositing aluminum-containing and silicon-containing deposits into the pores of the wood.

### DETAILED DESCRIPTION

The invention is generally discussed herein as a method of preserving wood comprising 1) providing a preservative composition, and 2) contacting or injecting the preservative composition into wood, where the wood preservative composition protects against fungal decay, termites and other insects, marine borers, acts as a sealant to protect wood from the natural effects of the environment such as rain and sun and inhibits warping, splitting, checking, and discoloration, and in some embodiments imparts to the treated wood a fire retardant which inhibits the spread of fire. The invention also encompasses the preservative compositions, as well as wood products that have been preserved with a composition of this invention. In a first embodiment, the process comprises injecting into wood an aqueous composition comprising or consisting essentially of dissolved/suspended alumina, dissolved/suspended silica, dissolved/suspended iron, and dissolved/suspended titania, and optionally one or more co-biocides selected from a biocidally effective amount of a substantially insoluble organic biocide, a biocidally effective amount of biocidal copper, zinc, nickel, and/or tin salts and/or oxides, or both. In one embodiment the composition is substantially free of substantially insoluble organic biocides. In one embodiment the composition is substantially free of biocidal copper, zinc, nickel, and/or tin salts and/or oxides. In one preferred embodiment the composition is substantially free of biocidal copper salts and/or oxides. Advantageously, the amount of dissolved/suspended silicon is between 10 mg SiO₂/L and 6000 mg SiO₂/L, for example between about 20 mg SiO₂/L and 2000 mg SiO₂/L. Advantageously, the amount of dissolved/suspended titanium is between 1 mg TiO₂/L and 2000 mg TiO₂/L, for example between about 10 mg TiO₂/L and 500 mg TiO₂/L. Advantageously, the amount of dissolved/suspended aluminum is between about 300 mg Al₂O₃/L and 20000 mg Al₂O₃/L, for example between about 500 mg Al₂O₃/L and 5000 mg Al₂O₃/L. Advantageously, the amount of dissolved/suspended iron is between about 50 mg Fe₂O₃/L and 20000 mg Fe₂O₃/L, for example between about 100 mg Fe₂O₃/L and 5000 mg Fe₂O₃/L. Advantageously the composition comprises more alumina than silica. For example, the weight ratio between dissolved/suspended alumina and dissolved/suspended silica may be between about 2:1 to about 50:1, for example between about 5:1 and 25:1. Advantageously the composition comprises more alumina than titania. For example, the weight ratio between dissolved/suspended alumina and dissolved/suspended titania may be between about 2:1 to about 500:1, for example between about 10:1 and 200:1. Advantageously the composition comprises more alumina than iron (as Fe₂O₃). For example, the weight ratio between dissolved/suspended alumina and dissolved/suspended iron (as Fe₂O₃) may be between about 1.1:1 to about 10:1, for example between about 1.5:1 and 3:1. In preferred embodiments the composition at the time of injection is acidic, e.g., comprising between about 0.01 moles to about 12 moles of acid per liter, for example between about 0.3 moles to about 2 moles per liter of acid. It is not clear at this point whether the biocidal activity is provided from the aluminum/alumina, silicon/silica, iron, titanium/titania, or some combination thereof. We suspect that the observed biocidal activity is the result of the combination of at least two precipitated dissolution products of strong acid with alumina, silica, iron, and titania, where the most likely required components are at least two of the precipitated dissolution product of strong acid with alumina, silica, iron, and titania.

Without being bound by theory, we believe that aluminum precipitated within the wood has primarily a biocidal activity, and secondary functions at reduce leaching of biocidal metals (if any are present) and to increase water repellancy activity. We believe that silicon precipitated within the wood has primarily a water repellancy activity, and secondary functions at reduce leaching of biocidal metals (if any are present) and to increase biocidal activity. We believe that titanium precipitated within the wood has primarily a biocidal activity. We believe that iron precipitated within the wood has primarily a UV protectant activity.

In a second embodiment, the process comprises injecting into wood an aqueous composition comprising or consisting essentially of dissolved/suspended alumina, dissolved/suspended silica, and dissolved/suspended titania, and optionally one or more co-biocides selected from a biocidally effective amount of a substantially insoluble organic biocide, a biocidally effective amount of biocidal copper, zinc, nickel, and/or tin salts and/or oxides, or both. In one embodiment the composition is substantially free of substantially insoluble organic biocides. In one embodiment the composition is substantially free of biocidal copper, zinc, nickel, and/or tin salts and/or oxides. In one preferred embodiment the composition is substantially free of biocidal copper salts and/or oxides. Advantageously, the amount of dissolved/suspended silicon is between 10 mg SiO₂/L and 6000 mg SiO₂/L, for example between about 20 mg SiO₂/L and 2000 mg SiO₂/L. Advantageously, the amount of dissolved/suspended titanium is between 1 mg TiO₂/L and 2000 mg TiO₂/L, for example between about 10 mg TiO₂/L and 500 mg TiO₂/L. Advantageously, the amount of dissolved/suspended aluminum is between about 300 mg Al₂O₃/L and 20000 mg Al₂O₃/L, for example between about 500 mg Al₂O₃/L and 5000 mg Al₂O₃/L. Advantageously the composition comprises more alumina than silica. For example, the weight ratio between dissolved/suspended alumina and dissolved/suspended silica may be between about 2:1 to about 50:1, for example between about 5:1 and 25:1. Advantageously the composition comprises more alumina than titania. Advantageously the composition comprises more alumina than titania. For example, the weight ratio between dissolved/suspended alumina and dissolved/suspended titania may be between about 2:1 to about 500:1, for example between about 10:1 and 200:1. In preferred embodiments the composition at the time of injection is acidic, e.g., comprising between about 0.01 moles to about 12 moles of acid per liter, for example between about 0.3 moles to about 2 moles per liter of acid.

In a third embodiment, the process comprises injecting into wood an aqueous composition comprising or consisting essentially of dissolved/suspended alumina, dissolved/suspended silica, and dissolved/suspended iron, and optionally one or more co-biocides selected from a biocidally effective amount of a substantially insoluble organic biocide, a biocidally effective amount of biocidal copper, zinc, nickel, and/or tin salts and/or oxides, or both. In one embodiment the composition is substantially free of substantially insoluble organic biocides. In one embodiment the composition is substantially free of biocidal copper, zinc, nickel, and/or tin salts and/or oxides. In one preferred embodiment the composition is substantially free of biocidal copper salts and/or oxides. Advantageously, the amount of dissolved/suspended silicon is between 10 mg SiO₂/L and 6000 mg SiO₂/L, for example between about 20 mg SiO₂/L and 2000 mg SiO₂/L. Advantageously, the amount of dissolved/suspended aluminum is between about 300 mg Al₂O₃/L and 20000 mg Al₂O₃/L, for example between about 500 mg Al₂O₃/L and 5000 mg Al₂O₃/L. Advantageously, the amount of dissolved/suspended iron is between about 50 mg Fe₂O₃/L and 20000 mg Fe₂O₃/L, for example between about 100 mg Fe₂O₃/L and 5000 mg Fe₂O₃/L. Advantageously the composition comprises more alumina than silica. For example, the weight ratio between dissolved/suspended alumina and dissolved/suspended silica may be between about 2:1 to about 50:1, for example between about 5:1 and 25:1. Advantageously the composition comprises more alumina than iron (as Fe₂O₃). For example, the weight ratio between dissolved/suspended alumina and dissolved/suspended iron (as Fe₂O₃) may be between about 1.1:1 to about 10:1, for example between about 1.5:1 and 3:1. In preferred embodiments the composition at the time of injection is acidic, e.g., comprising between about 0.01 moles to about 12 moles of acid per liter, for example between about 0.3 moles to about 2 moles per liter of acid.

In a fourth embodiment, the process comprises injecting into wood an aqueous composition comprising or consisting essentially of dissolved/suspended alumina and dissolved/suspended silica, and optionally one or more co-biocides selected from a biocidally effective amount of a substantially insoluble organic biocide, a biocidally effective amount of biocidal copper, zinc, nickel, and/or tin salts and/or oxides, or both. In one embodiment the composition is substantially free of substantially insoluble organic biocides. In one embodiment the composition is substantially free of biocidal copper, zinc, nickel, and/or tin salts and/or oxides. In one preferred embodiment the composition is substantially free of biocidal copper salts and/or oxides. The composition may comprise between 1.5 times to about 30 times, alternately between about 2 time to about 16 times as much dissolved/suspended aluminum (as Al₂O₃) as dissolved/suspended silicon (as SiO₂). Alternatively, the weight of aluminum (as alumina) is at least two times, preferably at least 3 times, for example between about 4 times or 5 times and about 20 times, alternately between about 4 times or 5 times and about 14 times, the weight of silicon (as silica) in the aqueous composition. Advantageously, the amount of dissolved/suspended silicon is between 10 mg SiO₂/L and 6000 mg SiO₂/L, for example between about 20 mg SiO₂/L and 2000 mg SiO₂/L. Advantageously, the amount of dissolved/suspended aluminum is between about 300 mg Al₂O₃/L and 20000 mg Al₂O₃/L, for example between about 500 mg Al₂O₃/L and 5000 mg Al₂O₃/L. Advantageously the composition comprises more alumina than silica. For example, the weight ratio between dissolved/suspended alumina and dissolved/suspended silica may be between about 2:1 to about 50:1, for example between about 5:1 and 25:1. In preferred embodiments the composition at the time of injection is acidic, e.g., comprising between about 0.01 moles to about 12 moles of acid per liter, for example between about 0.3 moles to about 2 moles per liter of acid.

In a fifth embodiment, the process comprises injecting into wood an aqueous composition comprising or consisting essentially of dissolved/suspended alumina and dissolved/suspended titania, and optionally one or more co-biocides selected from a biocidally effective amount of a substantially insoluble organic biocide, a biocidally effective amount of biocidal copper, zinc, nickel, and/or tin salts and/or oxides, or both. In one embodiment the composition is substantially free of substantially insoluble organic biocides. In one embodiment the composition is substantially free of biocidal copper, zinc, nickel, and/or tin salts and/or oxides. In one preferred embodiment the composition is substantially free of biocidal copper salts and/or oxides. Advantageously, the amount of dissolved/suspended titanium is between 1 mg TiO₂/L and 2000 mg TiO₂/L, for example between about 10 mg TiO₂/L and 500 mg TiO₂/L. Advantageously, the amount of dissolved/suspended aluminum is between about 300 mg Al₂O₃/L and 20000 mg Al₂O₃/L, for example between about 500 mg Al₂03/L and 5000 mg Al₂O₃/L. Advantageously the composition comprises more alumina than titania. For example, the weight ratio between dissolved/suspended alumina and dissolved/suspended titania may be between about 2:1 to about 500:1, for example between about 10:1 and 200:1. In preferred embodiments the composition at the time of injection is acidic, e.g., comprising between about 0.01 moles to about 12 moles of acid per liter, for example between about 0.3 moles to about 2 moles per liter of acid.

In a sixth embodiment, the process comprises injecting into wood an aqueous composition comprising or consisting essentially of dissolved/suspended silica and dissolved/suspended titania, and optionally one or more co-biocides selected from a biocidally effective amount of a substantially insoluble organic biocide, a biocidally effective amount of biocidal copper, zinc, nickel, and/or tin salts and/or oxides, or both. In one embodiment the composition is substantially free of substantially insoluble organic biocides. In one embodiment the composition is substantially free of biocidal copper, zinc, nickel, and/or tin salts and/or oxides. In one preferred embodiment the composition is substantially free of biocidal copper salts and/or oxides. Advantageously, the amount of dissolved/suspended silicon is between 10 mg SiO₂/L and 6000 mg SiO₂/L, for example between about 20 mg SiO₂/L and 2000 mg SiO₂/L. Advantageously, the amount of dissolved/suspended titanium is between 1 mg TiO₂/L and 2000 mg TiO₂/L, for example between about 10 mg TiO₂/L and 500 mg TiO₂/L. Advantageously the weight ratio between dissolved/suspended silica and dissolved/suspended titania is between about 1:1 to about 50:1, for example between about 1:5 and 1:25. The composition may advantageously further comprise iron. The composition may advantageously further comprise dissolved/suspended alumina. Advantageously the composition comprises more alumina than silica. In preferred embodiments the composition at the time of injection is acidic, e.g., comprising between about 0.01 moles to about 12 moles of acid per liter, for example between about 0.3 moles to about 2 moles per liter of acid.

In a seventh embodiment, the process comprises injecting into wood an aqueous composition comprising or consisting essentially of dissolved/suspended silica, dissolved/suspended alumina, dissolved/suspended titania, and optionally one or more co-biocides selected from a biocidally effective amount of a substantially insoluble organic biocide, a biocidally effective amount of biocidal copper, zinc, nickel, and/or tin salts and/or oxides, or both. In one embodiment the composition is substantially free of substantially insoluble organic biocides. In one embodiment the composition is substantially free of biocidal copper, zinc, nickel, and/or tin salts and/or oxides. In one preferred embodiment the composition is substantially free of biocidal copper salts and/or oxides. Advantageously, the amount of dissolved/suspended silicon is between 20 mg SiO₂/L and 6000 mg SiO₂/L, for example between about 40 mg SiO₂/L and 2000 mg SiO₂/L. Advantageously, the amount of dissolved/suspended titanium is between 1 mg TiO₂/L and 2000 mg TiO₂/L, for example between about 10 mg TiO₂/L and 500 mg TiO₂/L. Advantageously, the amount of dissolved/suspended aluminum is between about 50 mg Al₂O₃/L and 20000 mg Al₂O₃/L, for example between about 400 mg Al₂O₃/L and 5000 mg Al₂O₃/L. Advantageously the weight ratio between dissolved/suspended silica and dissolved/suspended titania is between about 1:1 to about 50:1, for example between about 1:5 and 1:25. The composition may advantageously further comprise iron. The composition may advantageously further comprise dissolved/suspended alumina. Advantageously the composition comprises more alumina than silica. In preferred embodiments the composition at the time of injection is acidic, e.g., comprising between about 0.01 moles to about 12 moles of acid per liter, for example between about 0.3 moles to about 2 moles per liter of acid.

In an eighth embodiment, the process comprises injecting into wood an aqueous solution comprising or consisting essentially of dissolved aluminum, silicon, optionally titanium, optionally iron, and optionally one or more co-biocides selected from a biocidally effective amount of a substantially insoluble organic biocide, a biocidally effective amount of biocidal copper, zinc, nickel, and/or tin salts and/or oxides, or both. In one embodiment the composition is substantially free of substantially insoluble organic biocides. In one embodiment the composition is substantially free of biocidal copper, zinc, nickel, and/or tin salts and/or oxides. In one preferred embodiment the composition is substantially free of biocidal copper salts and/or oxides. The composition advantageously comprises between 1.5 and 40 moles of aluminum per mole of silicon. Alternately, the composition comprises at least 2 times, preferably at least 3 times, for example between about 4 times or 5 times and about 20 times, alternately between about 4 times or 5 times and about 14 times, the weight of aluminum (as Al₂O₃) compared to the weight of silicon (as silica) in the aqueous composition. Advantageously, the composition comprises aluminosilicates. Advantageously, the amount of dissolved silicon is between 10 mg SiO₂/L and 6000 mg SiO₂/L, for example between about 20 mg SiO₂/L and 2000 mg SiO₂/L. Advantageously, the amount of dissolved aluminum is between about 300 mg Al₂O₃/L and 20000 mg Al₂O₃/L, for example between about 500 mg Al₂O₃/L and 5000 mg Al₂O₃/L. Advantageously the composition comprises more alumina than silica. For example, the weight ratio between dissolved alumina and dissolved silica may be between about 2:1 to about 50:1, for example between about 5:1 and 25:1. In preferred embodiments the composition at the time of injection is acidic, e.g., comprising between about 0.01 moles to about 12 moles of acid per liter, for example between about 0.3 moles to about 2 moles per liter of acid.

In another embodiment, the process comprises injecting into wood an acidic aqueous composition comprising, or alternately consisting essentially of, between about 100 and about 15000 mg/I, preferably between about 200 and about 10000 mg/l, for example between about 250 and about 1000 mg/l of aluminum; and between about 10 and about 4000 mg/I, preferably between about 20 and about 1000 mg/l, for example between about 40 and about 300 mg/l of silicon. It is believed that both the silicon and the aluminum exist in the aqueous composition combined with oxygen, e.g., as silicates and/or aluminates. In a preferred embodiment, the weight ratio of aluminum to silicon in the injected composition is between about 1:1 to about 40:1, preferably between about 1.2:1 to about 30:1, more preferably between about 1.5:1 to about 25:1, for example between about 3:1 and 15:1. Advantageously, the composition further comprises between 1 and 1000 mg/l, for example between 2 and about 100 mg/l of titanium. Alternately or additionally, the composition further comprises between about 50 and about 8000 mg/l, preferably between about 100 and about 5000 mg/l, for example between about 120 and about 500 mg/l of iron. It is believed that the titanium and possibly also a portion of the iron exist in the aqueous composition combined with oxygen.

In all of the above embodiments, the acid can be a mineral acid or a mixture of mineral acids, or a combination of at least one mineral acid and at least one organic acid. In any of the above embodiments, acids advantageously include mineral acids, for example hydrochloric acid, hydrofluoric acid, fluoroboric acid, sulfuric acid, sulfurous acid, sulfamic acid, nitric acid, phosphoric acid, phosphorus acid, phosphonic acid, boric acid, fluosilicic acid, or mixture thereof. Preferred mineral acids include hydrofluoric acid, hydrochloric acid, sulfuric acid, fuming sulfuric acid, or mixtures thereof. Advantageously, in one embodiment, the mineral acid does not comprise nitric acid. It is believed that available nitrates promote mold growth in wood.

A preferred acid, primarily from the standpoint of cost, is hydrochloric acid. If the acid consists essentially of hydrochloric acid, then the aqueous composition advantageously comprises 0.3% to 40% HCl, preferably 1% to 36%, more preferably 25% to 34% HCl. On the other hand, analysis of the extracts of kyanite obtained using hydrochloric acid suggested the acid dissolved only between 13 and 30 grams of mineral per liter of acid, of which about a quarter of that total was iron. Advantageously, if the acid comprises concentrated hydrochloric acid, then the composition is diluted to contain less than 20% HCl prior to injecting the composition into wood. It is preferred that the extracting acid be concentrated, e.g., greater than about 5 moles per liter, typically greater than about 8 moles per liter. Higher concentrations of hydrochloric acid promote flocculation of dispersed particles of silica. Gelling of the composition can occur, however, if the hydrochloric acid concentration is 20% or higher and the composition contains substantial quantities of silicates. The minimum viscosity of silica in HCl is at pH 2 to 3, and flocculation of silica particles is suppressed.

Dissolution of kyanite in concentrated hydrochloric acid provides poor and inconsistent solids recovery. Addition of a small amount of hydrofluoric acid would significantly increase dissolution and dissolution rates of hard minerals such as kyanite. Advantageously, if hydrofluoric acid is used, it is a minor component of the mineral acids (usually less than 5% by weight HF, for example between 0. 1% and 2% by weight HF based on the weight of the liquid acidic composition), and is combined with larger amounts of other mineral acids, e.g., concentrated hydrochloric acid. Therefore, another preferred acid is hydrofluoric acid admixed with one or more mineral acids selected from hydrochloric acid, fluoroboric acid, sulfuric acid, sulfurous acid, sulfamic acid, nitric acid, phosphoric acid, phosphorus acid, phosphonic acid, boric acid, or mixture thereof. A preferred acid comprises 5% to 34% HCl in water, and optionally also 0.1% to 5% HF, where there are between 4 and 400 moles of hydrochloric acid per mole of hydrofluoric acid.

Simple organic acids such as formic acid and acetic acid are useful, particularly if used with one or more mineral acids. Larger organic acids are less preferred. Organic acids are generally not strong enough to dissolve minerals which are preferred, inexpensive sources of Al, Si, Ti, and Fe. Preferably, if organic acids are present, they form only a minor part (less than half by weight) of the total weight of acid, with the majority of the acid comprising one or more mineral acids. One embodiment of the present invention is substantially free of organic acids. By substantially free of organic acids, we mean less than 0.05%, preferably less than 0.01% , of mineral acids based on the weight of the aqueous wood preserving composition.

Advantageously, the wood preserving compositions of this invention comprise soluble borates. If the wood treatment is intended for use primarily as a fire retardant, then incorporation zinc borate, borax, or other borates, for example in an amount sufficient to provide of 0.5 to 5 pounds of borate per cubic foot of wood, are useful. Alternatively the wood preserving compositions of this invention are substantially free of borates, e.g., the residue remaining from dried wood preservative composition comprises less than 0.5% borates. Borates are rapidly leached from wood.

Advantageously, in any of the above embodiments, the aqueous wood preservative composition further comprises at least one of copper, zinc, nickel, or tin. The amount of copper, zinc, nickel, tin or combinations thereof in the aqueous composition can range up to about 20000 mg/l, but is typically between about 50 mg/l and about 4000 mg/l. While one of the goals of our research was to find useful wood preservatives that were substantially free of copper, and even less importantly substantially free of zinc, nickel, and tin, the use of this composition in combination with soluble copper, zinc, tin, and/or nickel is expected to reduce leaching of these metals during subsequent aging. U.S. Pat. No. 6,579,354 teaches use of a composition having 44 parts of copper hydroxide, 24 parts of aluminum nitrate, and 46 parts of propionic acid as a wood preservative. Without being bound by theory, we believe that aluminum ions in our compositions begins to hydrolyze (i.e., precipitate as the hydroxide, basic hydroxide, and/or oxide) when the pH of its immediate environment reaches about 3.0 or 3.5. This generally occurs when the acid in the composition is neutralized by the wood and is lost to vaporization. For this reason volatile acids, e.g., hydrochloricd acid, hydrofluoric acid, acetic acid, and formic acid, are preferred. Copper, zinc, tin, nickel, and even non-biocidal metals such as iron in the composition can co-precipitate with the aluminum, forming a network where the biocidal metals are effectively trapped by precipitated alumina. This in turn should attenuate the leaching of for example copper from the acidic wood preserving solutions. In order to inject aluminum ion (for subsequent hydrolysis) the pH of the medium would have to be very acidic, for example at pH less than 2.5 for more lower aluminum concentrations to pH near 1 for higher concentrations of alumina. The addition of silica will add a water repellancy to the precipitated material, further attenuating the leaching of copper and other biocidal metals. Without being bound by theory, we believe the co-precipitation of the copper, nickel, tin, zinc, or any combination thereof with soluble aluminum and with soluble or colloidal silica will form a structure where leaching of copper is severely retarded.

The amount of biocidal metals used can vary, but the total moles of biocidal metal is advantageously less than the moles of aluminum in the wood preservative composition. If present, the amount of dissolved copper should be sufficient to provide between about 0.01 and about 0.25 pounds of copper per cubic foot of wood. If present, the amount of dissolved zinc should be sufficient to provide between about 0.01 and about 0.25 pounds of copper per cubic foot of wood.

In any of the above embodiments, the wood preservative composition is advantageously prepared by:

A) contacting a solid source of alumina (Al₂O₃) and silica (SiO₂) with an aqueous strongly acidic composition for a time and at a temperature sufficient to dissolve/suspend the alumina and silica, wherein there is advantageously an excess of the source(s) of alumina and silica so that there remains solid source material after the dissolution/suspension;

B) optionally, separating the aqueous strongly acidic composition from the remaining solid source after the dissolution/suspension;

C) optionally adding one or more organic biocides, one or more metal-containing biocides, or both, in a form wherein the resulting composition is a mixture, a slurry, an emulsion, or some combination thereof, D) optionally, diluting the aqueous composition with water, wherein the dilution is by a factor of between 1:0.1 to about 1:50 of parts (by weight) of the preservative composition to parts (by weight) of dilution water;

E) optionally adding base to adjust the pH the between about 0 and about 7.5, for example between about 1 to less than 7, alternately between about 1.5 and about 5.

The silica, alumina, iron, and/or titanium can be provided by adding soluble salts to an acidic composition. This is generally prohibitively expensive and is not particularly environmentally friendly. Alternatively, the wood preserving composition can be initially prepared by obtaining an acid extract from an appropriate mineral, and then any deficiencies in this extract can be remedied by adding soluble salts. If the wood preservative composition is formed by dissolving minerals comprising aluminum, titanium, and/or silicon, then advantageously the mineral is very finely ground. Advantageously the solid source comprises small particulates, e.g., between 10 mesh and 600 mesh, preferably between 120 mesh and 400 mesh, so that dissolution kinetics will be shortened but gravity separation of the solid source material and the liquid composition is still economically feasible. Preferably the mineral solids are smaller than 80 mesh, more preferably smaller than 120 mesh, for example smaller than 240 mesh.

Advantageously, the source of alumina and silica is kyanite. Kyanite has one mole of alumina per mole of silica, and the mineral is inexpensive, plentiful, and further commercially available kyanite typically contains minor amounts of titanium and/or iron. A preferred source is Kyanite having between 0. 1% and 5% titania and/or having between 0.1 to 5% iron oxide, such as can be commercially obtained from the Kyanite Mining Corp.

Other mineral sources can be used. The wood preservative compositions can advantageously be prepared by digesting in strong acid one or more of: 1) alumina, 2) silica, 3) kyanite (Aluminum Silicate, Al₂SiO₅) and its polymorphs and alusite and sillimanite, 4) kaolin, 5) mullite (3Al₂O₃.2SiO₂, but Mullite rarely occurs in nature), 6) Biotite [K (FE, Mg)₃AlSi₃O₁₀(F, OH)₂, 7) chloritoid (Iron Magnesium Manganese Aluminum Silicate Hydroxide), 8) Fayalite (Iron Silicate), 9) Titanite (Calcium Titanium Silicate), are/or aluminosilicates such as are commonly found in feldspars, e.g., 10) Albite, (Sodium aluminum silicate), 11) Oligoclase, (Sodium calcium aluminum silicate), 12) Andesine, (Sodium calcium aluminum silicate), 13) Elbaite, (Sodium Lithium Aluminum Boro-Silicate Hydroxide), 14) Microcline, (Potassium aluminum silicate), 15 Anorthite, (Calcium aluminum silicate), 16) Orthoclase, (Potassium aluminum silicate), 17) Kaolin (Al₂O₃ 2SiO₂ 2H₂O, and inexpensive grades often contain useful impurities such as 0.5-2% titania and iron oxides), 18) Sanidine, (Potassium sodium aluminum silicate), 19) smectites including magnesium aluminum silicate, magnesium and other (e.g. calcium) aluminium silicates such as Veegum™ in its various grades, and bentonite, and mixtures thereof.

The selection of minerals which can act as a source for aluminum, silicon, titalium, and other compounds depends on local availability and cost. Generally, less expensive grades of minerals are less pure than more expensive grades, and are preferred. An exemplary inexpensive grade bentonite has the following nominal composition: 54.3% silica, 18.3% Alumina, 10.9% Ferric Oxide, and 1.2% TiO₂. Generally, aluminosilicates in the form of clays and feldspars are easier to digest in strong acid, but they tend to cost more than mineral sources. Most of the above-described embodiments of the invention require a significant excess of aluminum (where the amount of aluminum is specified as alumina) relative to silica. Therefore, it is advantageous to have an excess of alumina to silica in source material. It is also possible to use alternatively or additionally soluble silicates, soluble aluminum salts, titania, or combinations thereof with one or more of the aforementioned minerals.

Heating the acid/mineral slurry, for example to a temperature between 300 and 60° C., and providing adequate turbulence can facilitate dissolution of mineral material (silica, alumina) into the acid.

Wet ball milling the minerals in the presence of the acid can also greatly facilitate the rate of dissolution of the mineral material. Said slurry of acid and mineral material is advantageously wet milled in a mall mill having milling media (beads) which preferably comprise a zirconium compound such as zirconium silicate or more preferably zirconium oxide. Such milling (or an equivalent milling process) will reduce dissolution time to less than a few hours, and will also further reduce the particle size of the mineral. It is known in the art that particles having a size below about 0.5 microns can be injected into wood. While submicron particles of the minerals used to provide a source of one or more of Al, Si, Ti, and Fe are not particularly useful biocidal material and do not contribute to water repellancy, if such particles exist they should have a maximum diameter less than 1 micron so that they can be readily injected into wood.

The compositions of the present invention can optionally contain a small quantity of surfactants. If surfactants are added, between 0.01% and 0.2% is expected to be a sufficient quantity to provide the desired results. In other embodiments of the invention, the composition is substantially free of surfactants.

Another particular aspect of the invention relates to the above-described formulations which further comprise one or more pigments and/or dyes in “an amount sufficient to impart a discemable color to the wood.” If the manufacturer wants wood with a specified color, the dye would be present in an amount sufficient to impart a discemable color to the wood if, when compared to identical wood treated with the same particulate biocidal materials in the same concentration but without the dyes and/or pigments, there is a difference in the color of the wood discemable to a majority of people not afflicted by color blindness. Absence of a visually apparent color, when compared to identical wood treated with the same particulate biocidal materials in the same concentration but without having the pigments and dyes, also satisfies the phrase comprising pigments and/or dyes in “an amount sufficient to impart a discemable color to the wood.” There are a large number of pigments and dyes known in the industry, and many are applicable for various embodiments of this invention. The slurries include dispersants that adhere to pigments and promote stability of the slurry by retarding agglomeration of particles in the slurry. In one embodiment, one or more dispersants are co-emulsified with the one or more pigments and/or dyes.

The composition may further comprise submicron injectable pigments such as iron oxide, copper oxide, nickel oxide, tin oxide, zinc oxide, titanium oxide or any combination thereof. We believe iron forms in situ iron oxide, a pigment preferred for its UV protecting properties. The preserved wood without the dye and/or pigment has an undesired visually apparent color. Wood treated with the compositions of this invention tend to turn dark, so light pigments, particularly zinc oxide, titanium oxide, and/or zinc phosphates, are preferred. Masking such undesirable darkness, when compared to identical wood treated with the same particulate biocidal materials in the same concentration but without the pigments and/or dyes, would satisfy the phrase comprising pigments and/or dyes in “an amount sufficient to impart a discemable color to the wood.”

Advantageously, both the wood preservative compositions are substantially free of hazardous material. By “substantially free of hazardous material” we mean the preservative treatment is substantially free of materials such as lead, arsenic, chromium, and the like. By substantially free of lead we mean less than about 0.1% by weight, preferably less than about 0.01% by weight, more preferably less than about 0.001% by weight, based on the dry weight of the wood preservative. By substantially free of arsenic we mean less than about 5% by weight, preferably less than about 1% by weight, more preferably less than about 0.1% by weight, for example less than about 0.01% by weight, based on the dry (water-free) weight of the wood preservative. By substantially free of chromium we mean less than about 0.5% by weight, preferably less than about 0.1% by weight, more preferably less than about 0.01% by weight, based on the dry weight of the wood preservative.

Advantageously, the wood preservatives are beneficially free of organic solvents. By substantially free we mean the treatment comprises less than about 10% organic solvents, preferably less than about 5% organic solvents, more preferably less than about 1% organic solvents, for example free of organic solvents, based on the water-free weight of the wood preservative composition. Biocidal quaternary amines are not organic solvents. In preferred embodiments of this invention, the slurry is free of solvents, e.g., the slurry comprises less than about 0.1% organic solvents, or is completely free of organic solvents.

The wood preservative composition may comprise organic biocides, which may or may not be substantially insoluble. By “substantially insoluble” we mean the organic biocide has a solubility in water of less than about 0.1%, and most preferably less than about 0.01%, for example in an amount of between about 0.005 ppm and about 1000 ppm, alternatively between about 0.1 ppm and about 100 ppm or between about 0.01 ppm and about 200 ppm, in water. As used herein, the term “organic biocide” may include, for example, one or more biocides selected from triazole compounds, quarternary amine compounds, nitroso-amine compounds, halogenated compounds, or organometalic compounds. Exemplary organic biocides can include, but are not limited to, azoles such as azaconazole, bitertanol, propiconazole, difenoconazole, diniconazole, cyproconazole, epoxiconazole, fluquinconazole, flusiazole, flutriafol, hexaconazole, imazalil, imibenconazole, ipconazole, tebuoonazole, tetraconazole, fenbuconazole, metconazole, myclobutanil, perfurazoate, penconazole, bromuconazole, pyrifniox, prochloraz, triadimefon, triadlmenol, triffumizole, or triticonazole; pyrimidinyl carbinoles such as ancymidol, fenarimol, or nuarimol; chlorothalonil; chlorpyriphos; N-cyclohexyldiazeniumdioxy; dichlofluanid; 8-hydroxyquinoline (oxine); isothiazolone; imidacloprid; 3-iodo-2-propynylbutylcarbamate tebuconazole; 2-(thiocyanomethylthio)benzothiazole (Busan 30); tributyltin oxide; propiconazole; synthetic pyrethroids; 2-amino-pyrimidine such as bupirimate, dimethirimol or ethirimol; morpholines such as dodemorph, fenpropidin, fenpropimorph, spiroxanin or tridemorph; anilinopyrimdines such as cyprodinil, pyrimethanil or mepanipyrim; pyrroles such as fenpiclonil or fludioxonil; phenylamides such as benalaxyl, furalaxyl, metalaxyl, R-metalaxyl, ofurace or oxadixyl; benzimidazoles such as benomyl, carbendazim, debacarb, fuberidazole or thiabendazole; dicarboximides such as chlozolinate, dichlozoline, iprdine, myclozoline, procymidone or vinclozolin; carboxamides such as carboxin, fenfuram, flutolanil, mepronil, oxycarboxin or thifluzamide; guanidines such as guazatne, dodine or iminoctadine; strobilurines such as azoxystrobin, kresoxim-methyl, metominostrobin, SSF-129, methyl 2-[(2-trifluoromethyl)pyrid-yloxymethyl]-3methoxycacrylate or 2-[α{[(α-methyl-3-trifluoromethyl-benzyl)imino]oxy}-o-tolyl]glyoxylic acid-methylester-O-methyloxime(trifloxystrobin); dithiocarbamates such as ferbam, mancozeb, maneb, metiram, propineb, thiram, zineb, or ziram; N-halomethylthio-dicarboximides such as captafol, captan, dichlofluanid, fluorormide, folpet, or tolfluanid; nitrophenol derivatives such as dinocap or nitrothal-isopropyl; organophosphorous derivatives such as edifenphos, iprobenphos, isoprothiolane, phosdiphen, pyrazophos, or toclofos-methyl; and other compounds of diverse structures such as aciberolar-S-methyl, anilazine, blasticidin-S, chinomethionat, chloroneb, chlorothalonil, cymoxanil, dichlone, dicomezine, dicloran, diethofencarb, dimethomorph, dithianon, etridiazole, famoxadone, fenamidone, fentin, ferimzone, fluazinam, flusuffamide, fenhexamid, fosetyl-alurinium, hymexazol, kasugamycin, methasuifocarb, pencycuron, phthalide, polyoxins, probenazole, propamocarb, pyroquilon, quinoxyfen, quintozene, sulfur, triazoxide, tricyclazole, triforine, validamycin, (S)-5-methyl-2-methylthio-5-phenyl-3-phenyl-amino-3,5-dihydroimidazol-4-one (RPA 407213), 3,5-dichloro-N-(3-chloro-1-ethyl-1-methyl-2-oxopropyl)-4-methylbenzamide (RH7281), N-alkyl-4,5-dimethyl-2-timethylsilythiophene-3-carboxamide (MON 65500), 4-chloro-4-cyano-N,N-dimethyl-5-p-tolylimidazole-1-sulfonamide (IKF-916), N-(1-cyano-1,2-dimethylpropyl)-2-(2,4-dichlorophenoxyy)-propionamide (AC 382042), iprovalicarb (SZX 722), or quaternary ammonium compounds of general formula of N—R₁R₂R₃R₄-X, wherein R₁, R₂, R₃ and R₄ are selected from the group consisting of hydrogen, a C₁ to C₁₈ alkyl, a C₁ to C₁₈ alkoxy, a C₁ to C18 alkenyl, a C₁ to C₁₈ alkynyl, a C₅ to C₁₂ aryl, a C₅ to C₁₂ aralkyl, or a C₅ to C₁₂ aroyl, wherein at least two R groups are not hydrogen and at least one R group comprises six or more carbon atoms (for example, a didecyl-dimethyl-ammonium salt), and wherein X is selected from the group consisting of hydroxide, chloride, fluoride, bromide, carbonate, bicarbonate, sulfate, nitrate, acetate, phosphate, or any mixture thereof. Also included are the biocides including pentachlorophenol, phenothrin, phenthoate, phorate, as well as trifluoromethylpyrrole carboxamides and trifluoromethylpyrrolethioamides described in U.S. Patent No. 6,699,818; triazoles such as amitrole, azocylotin, bitertanol, fenbuconazole, fenchlorazole, fenethanil, fluquinconazole, flusilazole, flutriafol, imibenconazole, isozofos, myclobutanil, metconazole, epoxyconazole, paclobutrazol, (±)-cis-1-(4-chlorophenyl)-2-(1H-1,2,4-triazol-1-yl)-cycloheptanol, tetraconazole, triadimefon, triadimenol, triapenthenol, triflumizole, triticonazole, uniconazole and their metal salts and acid adducts; Imidazoles such as Imazalil, pefurazoate, prochloraz, triflumizole, 2-(1-tert-butyl)-1-(2-chlorophenyl)-3-(1,2,4-triazol-1-yl)-propan-2-ol, thiazolecarboxanilides such as 2′,6′-dibromo-2-methyl-4-trifluoromethoxy-4′-trifluoromethyl-1,3-thiazole-5-carboxanilide, azaconazole, bromuconazole, cyproconazole, dichlobutrazol, diniconazole, hexaconazole, metconazole, penconazole, epoxyconazole, methyl (E)-methoximino[α-(o-tolyloxy)-o-tolyl)]acetate, methyl (E)-2-{2-[6-(2-cyanophenoxy)-pyrimidin-4-yl-oxy]phenyl}-3-methoxyacrylate, methfuroxam, carboxin, fenpiclonil, 4(2,2-difluoro-1,3-benzodioxol-4-yl)-1H-pyrrole-3-carbonitrile, butenafine, 3-iodo-2-propinyl n-butylcarbamate; triazoles such as described in U.S. Pat. Nos. 5,624,916, 5,527,816, and 5,462,931; the biocides described in U.S. Patent No. 5,874,025; 5-[(4-chlorophenyl)methyl]-2,2-dimethyl-1-(1H-1,2,4-triazol-1-yl-methyl)cyclopentanol; imidacloprid, 1-[(6-chloro-3-pyridinyl)-methyl]-4,5-dihydro-N-nitro-1H-imidazole-2-amine; methyl(E)-2-[2-[6-(2-cyanophenoxy)pyrimidin-4-yloxy]phenyl]-3-methoxyacrylate, methyl(E)-2-[2-[6-(2-thioamidophenoxy)pyrimidin-4-yloxy]phenyl]-3-methoxyacrylate, methyl(E)-2-[2-[6-(2-fluorophenoxy)pyrimidin-4-yloxy]phenyl]-3-methoxyacrylate, methyl(E)-2-[2-[6-(2,6-difluorophenoxy)pyrimidin-4-yloxy]phenyl]-3-methoxyacrylate, methyl(E)-2-[2-[3-(pyrimidin-2-yloxy)phenoxy]phenyl]-3-methoxyacrylate, methyl(E)-2-[2-[3-(5-methylpyrimidin-2-yloxy)-phenoxy]phenyl]-3-methoxyacrylate, methyl(E)-2-[2-[3-(phenylsulphonyloxy)phenoxy]phenyl]-3-methoxyacrylate, methyl(E)-2-[2-[3-(4-nitrophenoxy)phenoxy]phenyl]-3-methoxyacrylate, methyl(E)-2-[2-phenoxyphenyl]-3-methoxyacrylate, methyl(E)-2-[2-(3,5-dimethylbenzoyl)pyrrol-1-yl]-3-methoxyacrylate, methyl(E)-2-[2-(3-methoxyphenoxy)phenyl]-3-methoxyacrylate, methyl(E)-2-[2-(2-phenylethen-1-yl)-phenyl]-3-methoxyacrylate, methyl(E)-2-[2-(3,5-dichlorophenoxy)pyridin-3-yl]-3-methoxyacrylate, methyl(E)-2-(2-(3-(1,1,2,2-tetrafluoroethoxy)phenoxy)phenyl)-3-methoxyacrylate, methyl(E)-2-(2-[3-(α-hydroxybenzyl)phenoxy]phenyl)-3-methoxyacrylate, methyl(E)-2-(2-(4-phenoxypyridin-2-yloxy)phenyl)-3-methoxyacrylate, methyl(E)-2-[2-(3-n-propyloxyphenoxy)phenyl]-3-methoxyacrylate, methyl(E)-2-[2-(3-isopropyloxyphenoxy)phenyl]-3-methoxyacrylate, methyl(E)-2-[2-[3-(2-fluorophenoxy)phenoxy]phenyl]-3-methoxyacrylate, methyl(E)-2-[2-(3-ethoxyphenoxy)phenyl]-3-methoxyacrylate, methyl(E)-2-[2-(4-tert-butylpyridin-2-yloxy)phenyl]-3-methoxyacrylate; fenfuram, furcarbanil, cyclafluramid, furmecyclox, seedvax, metsulfovax, pyrocarbolid, oxycarboxin, shirlan, mebenil(mepronil), benodanil, flutolanil; benzimidazoles such as carbendazim, benomyl, furathiocarb, fuberidazole, thiophonatmethyl, thiabendazole or their salts; morpholine derivatives such as tridemorph, fenpropimorph, falimorph, dimethomorph, dodemorph; aldimorph, fenpropidine, and their arylsulphonates, such as, for example, p-toluenesulphonic acid and p-dodecylphenylsulphonic acid; benzothiazoles such as 2-mercaptobenzothiazole; benzamides such as 2,6-dichloro-N-(4-trifluoromethylbenzyl)-benzamide; formaldehyde and formaldehyde-releasing compounds such as benzyl alcohol mono(poly)-hemiformal; oxazolidine; hexa-hydro-S-triazines; N-methylolchloroacetamide; paraformaldehyde; nitropyrin; oxolinic acid; tecloltalam; tris-N-(cyclohexyldiazeneiumdioxy)-aluminium; N-(cyclohexyldiazeneiumdioxy)-tributyltin; N-octyl-isothiazolin-3-one; 4,5-trimethylene-isothiazolinone; 4,5-benzoisothiazolinone; N-methylolchloroacetamide; pyrethroids such as allethrin, alphamethrin, bioresmethrin, byfenthrin, cycloprothrin, cyfluthrin, decamethrin, cyhalothrin, cypermethrin, deltamethrin, α-cyano-3-phenyl-2-methylbenzyl-2,2-dimethyl-3-(2-chloro-2-trifluoro-methylvinyl)cyclopropane-carboxylate, fenpropathrin, fenfluthrin, fenvalerate, flucythrinate, flumethrin, fluvalinate, permethrin, resmethrin, and tralomethrin; nitroimines and nitromethylenes such as 1-[(6-chloro-3-pyridinyl)-methyl]-4,5-dihydro-N-nitro-1H-imidazol-2-amine (imidacloprid), N-[(6-chloro-3-pyridyl)methyl]-N²-cyano-N¹-methylacetamide (NI-25); quaternary ammonium compounds such as didecyldimethylammonium salts, benzyldimethyltetradecylammonium chloride, benzyldimethyldodecylammonium chloride, didecyldimethaylammonium chloride, and the like; phenol derivatives such as tribromophenol, tetrachlorophenol, 3-methyl-4-chlorophenol, 3,5-dimethyl-4-chlorophenol, phenoxyethanol, dichlorophene, o-phenylphenol, m-phenylphenol, p-phenylphenol, 2-benzyl-4-chlorophenol, and their alkali metal and alkaline earth metal salts; iodine derivatives such as diiodomethyl p-tolyl sulphone, 3-iodo-2-propinyl alcohol, 4-chloro-phenyl-3-iodopropargyl formal, 3-bromo-2,3-diiodo-2-propenyl ethylcarbamate, 2,3,3-triiodoallyl alcohol, 3-bromo-2,3-diiodo-2-propenyl alcohol, 3-iodo-2-propinyl n-butylcarbamate, 3-iodo-2-propinyl n-hexylcarbamate, 3-iodo-2-propinyl cyclohexyl-carbamate, 3-iodo-2-propinyl phenylcarbamate, and the like; microbicides having an activated halogen group such as chloroacetamide, bronopol, bronidox, tectamer, such as 2-bromo-2-nitro-1,3-propanediol, 2-bromo-4′-hydroxy-acetophenone, 2,2-dibromo-3-nitrile-propionamide, 1,2-dibromo-2,4-dicyanobutane, β-bromo-β-nitrostyrene, and the like; and the like; and combinations thereof. These are merely exemplary of the known and useful biocides, and the list could easily extend further.

Advantageously, the dispersants can also fix pigments or dyes to the external surface of biocidal particles. A strongly anionic dispersant is generally recommended to disperse and stabilize a slurry of for example sparingly soluble copper salts in water. Examples of such anionic surfactants or dispersant systems are sodium poly(meth)acrylate, sodium lignosulphonate, naphthalene sulphonate, etc. If pigments and/or dyes are cationic in nature, they will be attracted to the anionic dispersant-covered surface of biocidal particulates during milling. Care should be taken not to add an excess of cationic material, or slurry instability and precipitation will result. Formulations to overcome this tendency often utilize extremely high concentrations of anionic dispersants, e.g., the greater of between 5 to 15 grams of surfactants per gram of quaternary ammonium compound, or between 0.8 to 2 grams dispersants per gram of copper-containing particles.

In a preferred embodiment, the liquid carrier consists essentially of water and optionally one or more additives to aid dispersion, to provide pH maintenance, to modify interfacial tension (surfactants), and/or to act as anticoagulants. In another embodiment, the carrier consists essentially of water; optionally one or more additives to aid particulate dispersion, to provide pH maintenance, to modify interfacial tension (surfactants), and/or to act as anticoagulants; and an emulsion of oil or surfactants comprising organic biocides, oil-soluble dyes, or both dissolved and/or dispersed therein.

Wood is preserved by contacting, preferably by injecting, the liquid composition obtained above into wood, and then by drying at least a portion of the liquid from the wood, thereby depositing aluminum-containing (probably alumina) and silicon-containing (probably silica) deposits into the pores of the wood. The wood may be contacted by immersing the wood in the aqueous mixture at a pressure above atmospheric pressure in a closed container or may be sprayed or brushed on. Once dried the wood is very resistant to rot, insects, and other environmental insults.

Wood or wood products comprising the wood preservative compositions in accordance with the present invention may be prepared by any subjecting the wood to any standard injection practice currently used for injecting soluble wood treatments into wood. A preferred injection procedure includes the following four steps:
1) At least partially drying the wood, for example drying to remove at least 30%, preferably at least 50%, of the total moisture that can be removed by air drying the wood in ambient conditions. Green wood comprises sufficient air volume that a sufficient amount of wood preservative can be injected, but a more concentrated slurry would be required as compared to injecting into (at least partially) dried wood.
2) Subject the wood to vacuum, e.g, to below about 0.5 atmospheres and the injecting the slurry, and/or subject the wood to pressurized carbon dioxide, e.g., above about 30 psig, then vent the wood to atmospheren and inject the slurry. When slurry is injected into wood, the air in the wood is compressed. If no vacuum and/or carbon dioxide exposure is used, then the air in the wood will be compressed to one tenth of its original volume which will typically be in the center of the wood, and the slurry will therefore not reach the center one tenth of the wood. Further, releasing pressure causes the air to expand and push a portion of the injected fluid out from the wood, and this fluid may contain biocidal particles and/or pigment particles. A vacuum of as low as one half an atmosphere will reduce the amount of wood the slurry will not penetrate from one tenth to one twentieth of the total wood volume, and on releasing the pressure much less of the injected fluid will be expelled by the expanding air. Injecting carbon dioxide into the wood and then venting this to atmospheric pressure prior to injection will cause a portion of the air in the wood to be replaced by carbon dioxide. Carbon dioxide is so soluble in the slurry that it acts much like a vacuum, in that the carbon dioxide once dissolved in the water will not be compressed and will not keep slurry from being injected into wood.
3) Inject the injectable aqueous slurry into the wood by immersing the wood in the slurry and then exerting an injection pressure of from above atmospheric pressure to about 300 psi, typically between about 75 psi and 150 psi. Injection of particles into the wood or wood product from a flowable material comprising the particles may require marginally longer (10 to 50% longer) pressure treatments than would be required for liquids free of such particles. The pressure is then maintained for a period of time that can range from a few minutes to many hours, and then the pressure is released. The drier the wood is made in step 1 prior to injection and the more rigorous the vacuum and/or carbon dioxide exposure is in step 2, the less time is needed where pressure should be maintained. Time is important, because most commercial slurries will have some small amount of particle settling, and long holding times will allow a greater amount of the particles in slurry outside the wood to settle on and stain the exterior surface of the wood. If using 150 psi injection pressure on wood having less than half of the water originally in the green wood, and also being exposed to sufficient vacuum and/or carbon dioxide cycles to remove 90% of the air in the dried wood, then the pressure maintenance period can usually be reduced to between 2 and 15 minutes (depending on the thickness of the wood being treated).
4) At least partially dry the wood, to further fixate the injected particles into the wood matrix.

The Examples described below are illustrative and are not intended to limit the invention in any manner.

### EXAMPLES

### Example 1

For testing purposes, we extracted an Aluminum and Silicon rich solution from the naturally occurring mineral Kyanite having between 0.1% and 2% titania and having between 0.1 to 3% iron oxide, commercially obtained from the Kyanite Mining Corp. Data on the actual Kyanite used is presented below.

| Chemical Analysis | (wt %) |
|---|---|
| Al2O3 | 54-60 |
| SiO₂ | 39.0-42.0 |
| TiO₂ | 0.5-1.6 |
| Fe2O3 | 0.42-1.0 |
| CaO, MgO, Na₂O | <0.04 |
| K₂O | <0.07 |
| P₂O₅ | <0.02 |

The kyanite used is clearly not pure kyanite, which is simply a mineral with one mole of silica per mole of alumina, which would have 37% SiO₂ and 63% Al₂O₃. This Kyanite clearly has about 5 to 10% quartz, a few percent of other minerals, and about 90% Kyanite. Kyanite has a Specific gravity 3.2-3.6, a hardness of 4 to 7.4 on Mohrs Scale, Lath-like Crystal Particle Shape, and has a Bluish Gray Color. The most preferred embodiment of this invention utilizes an extract of this kyanite with the impurities that are present.

The Kyanite used for this project was 300 to 325 mesh to increase the speed of dissolution. For these examples we used concentrated Hydrochloric Acid to break down a fine Kyanite powder and put Al₂O₃ and SiO₂ into solution/suspension. About 10 grams of Kyanite was placed in 30 mls of concentrated Hydrochloric Acid. Alternately, about 20 grams of Kyanite was placed in 20 mls of concentrated Hydrochloric Acid. The difference is not believed to be significant, as only a very small fraction of the Kyanite was solubilized. The slurry was stirred and well shaken, then allowed to settle out for at least 24 hours at ambient temperature. There are a number of techniques that could greatly increase the rate of kyanite digestion, including utilizing an elevated temperature, continuous stirring, or most beneficially a wet milling process utilizing a milling material such as 0.5 mm to 2 mm zirconia. This milling process would pulverize the kyanite into particles having a diameter of ten microns or less, and will greatly increase the kyanite dissolution rate, such that an extract could be obtained in less than 1 hour.

The color of the extractant is green. Subsequent analysis revealed that the extract had a specific gravity of 1.15-1.16, a total acidity of 32% as HCl, sulphates 0.02% as H₂SO₄, 6 mg/L Iron, 5 mg/L free chlorine, 100 to 150 mg/L of apparent organic residue, and Nil sulfites and mercury.

The above solution is diluted and used in direct contact and also vacuum-assisted injection treatment. Sample A was pure extract, Sample B was 3 volumes extract diluted with 7 volumes of water, Sample C was 1 volume extract diluted with 9 volumes of water, Sample D was 3 volumes extract diluted with 97 volumes of water, and Sample E was 1 volume extract diluted with 99 volumes of water.

The wood used for evaluation was kiln dried untreated southern ponderosa pine. The wood was cut into 3 inch long ¼ inch by ¼ inch rectangular shapes. Such a thin piece of wood was able to readily absorb liquids without using pressure injection. For impregnation tests, a preferred procedure is to put the wood into a vacuum, and then introduce treating fluid into the vacuum chamber in an amount sufficient to fill the chamber. In these samples, however, no vacuum was pulled on the samples. The blocks remained immersed in the solution for a time, and then the blocks were removed, wiped free of residual liquid, and were allowed to dry prior to testing. The weight change of the samples suggested that the wood absorbed and retained about 5.7 grams to about 14.8 grams of preservative, averaging about 10 grams of preservative, per 100 grams of wood with no vacuum applied. The samples of wood weighed between 2.3 and 2.8 grams, and the weight gain after immersion in treating fluid varied between 0.147 grams and 0.369 grams. With the possible exception of Sample E, which had about one half the weight gain exhibited by the other samples, the weight gain does not correlate with dilution.

The first series of tests were extreme environmental weathering tests which involved exposing treated samples to temperature that alternated between about 12 hours at 50° C. (with constant UVA/UVB exposure) to about 12 hours at 0° C. Constant UVA/UVB exposure was provided by a light rated at 1200 LUX, where exposure experienced by any one sample was between about 100-200 LUX. Such intense exposure conducted over a 30 day time interval is estimated to simulate a 5-10 year exposure time to sunlight. One group of samples was dipped once daily such that about 80% of the wood volume was immersed in a solution of moderately hard water. The exposures and dipping were performed in replicates sufficient to enable toxicity testing at the 10, 20, 30, and 90 day time intervals without influencing the integrity of the leaching via dilution or concentration. Another set of samples remained dry.

The exposure to the acidic Kyanite extract produced a light gray appearance on the untreated wood. The wood face remained smooth. Resistance to puncture and grain definition appeared to be unchanged or slightly worse when compared to untreated wood. On a scale of −10(light) to 0 (neutral) to 10 (dark), three evaluators gave wood samples treated with undiluted Sample A scores that ranged from 3 to 10, with a mean of about 7. The color of the samples undergoing the accelerated weathering was compared to the color of a sample treated the same but not undergoing the extreme weathering. The extreme weathering environment—repeated cycling between temperature extremes with UVA/UVB exposure—did not result in any significant additional color change for sixty days. At ninety days, some samples remained the same color, while one dipped sample appeared slightly darker, and some appeared lighter (scores change from 9 to 5, 8 to 5, 8 to 6, and 8 to 6 on the aforementioned scale were typical). There was also clearer definition of the wood grains in some samples. Resistance to puncture was unchanged to slightly degraded compared to untreated, unexposed wood. We concluded that there were no significant color changes associated with the accelerated weathering environment after the initial application had dried.

Wood treated with the kyanite extract exhibited some water repellancy. The degree of water repellancy was evaluated by immersing a sample into water and recording any weight gain. The degree of water repellancy for most samples was good, with little observable change over 90 days exposure to the extreme weathering environment. Only for those Sample E samples that were dipped daily in water was the water repellancy found to be significantly degraded after 90 days. This was not unexpected—Sample E was treated with the 1 volume % extract, and this sample had the lowest retention of preservative material following the initial treatment.

Samples were exposed to moist dark conditions, with exposure to termites and three types of mold. A mold box was prepared using three types of wood molds (obtained by scraping molds readily apparent on untreated wood at a large lumber treatment facility), two types of fungus/lichens, and infesting wood insects. The box was prepared 60 days prior to exposure of wood. The box is kept modestly moist and dark with a light rating of 25 LUX and a temperature of about 20° C. to simulate the best growth conditions. All of Samples A, B, and C exhibited acceptable resistance to attack over 90 days. The not-dipped-daily-in-water Sample D samples also exhibited acceptable resistance to attack over 90 days. However, those Sample D (3 volume %) samples that were dipped daily in water, as well as both the dipped and the not-dipped-daily-in-water Sample E samples, exhibited unacceptable resistance to attack over 90 days.

### Example 2

In Example 2, the toxicity of the extractant was determined. The water collected from the dipping steps was evaluated using a WET test definitive (using C. dubia), and the WET LC50 @1″ of rainfall exposure value was calculated. A statistical amount of C. dubia were exposed the a concentration of the extractant, wherein the mortality of the C. dubia exposed to the extractant was determined after the requite time.

Samples exposed to a 1% extractant (in water) gave 100% mortality. Samples with 0.5% extractant (in water) gave 65% mortality. Both of these values are consistent with what would be expected if 1% and 0.5% of concentrated hydrochloric acid (in water) were tested. Further, samples with 0.25%, 0.125%, 0.0063%, and a control with 0% extractant in water each resulted in 0% mortality. The principal environmental effect against C. dubia seems to be the result of the acid.

Much of this acid would be dissipated from the wood prior to the wood being sold and used. As described in Example 1, a wood sample treated with pure kyanite-HCl extract was dipped daily into hard water, forming a leachate. Toxicity testing on the samples of leachate revealed 0% mortality of C. dubia. After 10, 30, 60, and 90 days of dipping into this water, aliquots of this water were analyzed. Analysis of the leachates revealed a trace of aluminum (up to 0.38 mg Al/L), a trace of silica (between 1.9 and 3.4 mg Si/L), and a few parts per million of potassium (about 7 mg K/L). The level of titanium was less than 0.01 mg Ti/L, and the amount of iron was less than 0.4 mg Fe/L.

### Example 3

In example 1, only a very small fraction of the Kyanite was found to be dissolved by the acid. The Kyanite was subsequently exposed to four additional extraction processes, each duplicating the procedure described in Example 1. That is, the original sample which contained about 20 grams of kyanite was sequentially exposed to four additional 24 hour extractions with fresh concentrated hydrochloric acid. Each of these extracts were analyzed. The data, shown in Table 1 below, is somewhat perplexing. The data seem to show that the quantity of Al, Si, and Fe in the leachate declined significantly with consecutive Teachings. However, of the 20,000 mg of commercially obtained Kyanite subject to the five extraction processes, analysis of the extractant suggests that only about 227 mg (or about 1.1% of the total material) was dissolved in all of the tests combined. It is not known what might account for these results—it may be that only fresh surfaces of kyanite are subject to dissolution by the hydrochloric acid. Such would be the result if only stressed crystals of kyanite dissolved, e.g., kyanite having a crystal structure stressed by the inclusion of the impurities, kyanite having a crystal structure stressed by the grinding process used to form the 300-325 mesh product, or both.

TABLE 1
Concentration of Components in Successive Extractions of Kyanite

| | Extraction | | | | |
|---|---|---|---|---|---|
| | first | second | third | fourth | fifth |
| Al (as mg/L Al₂O₃) | 5800 | 1960 | 1240 | 669 | 411 |
| Si (as mg/L SiO₂) | 1110 | 2.9 | 42.5 | 2.4 | 1.51 |
| Ti (as mg/L TiO₂) | 54.2 | 14.8 | 11.5 | 7 | 3.6 |

The above data is the reason that kyanite extraction that includes milling of the kyanite material is believed to be a preferred embodiment.

### Example 4

Another extraction kyanite, using equal weights of hydrochloric acid and of commercially available 300 to 325 mesh kyanite, was performed. The kyanite was mixed into the acid with stirring, and the material was allowed to sit for 24 hours. The liquid after extraction had 24900 mg/l total of calculated dissolved solids:

8780 mg Al/L is equivalent to 16600 mg Al₂O₃/IL;

657 mg Si/L is equivalent to 1409 mg SiO₂/L;

59 mg Ti/L is equivalent 99 mg TiO₂/L;

4360 mg Fe/L is equivalent to 6234 mg Fe₂O₃/L;

88 mg Ca/L is equivalent to 123 mg CaO/L;

180 mg Mg/L is equivalent to 298 mg MgO/L; and

56 mg P/L is equivalent to 128 mg P₂O₅/L.

The extractant also contained between 200 and 250 mg/L each of sodium and potassium.

Since equal weights of Kyanite and concentrated acid were used in this extraction, the hydrochloric acid apparently dissolved about 2.49% of the Kyanite originally present. Iron oxides are not believed to be sufficiently biocidal for use in wood when used by themselves. Assuming the Kyanite used in this extraction had the midpoint of the ranges provided by the supplier, e.g., 57% Al₂O₃, 40.5% SiO₂, 1.05% TiO₂, 0.7% Fe₂O₃, <0.04% each of CaO and MgO, and <0.02% P₂O₅, then the acid digestion dissolved about 2.9% of the available alumina, about 1.2% of the available silica, about 1% of the available titania, about 90% of the available Fe₂O₃, and between 30% and 70% of the available CaO, MgO, and P₂O₅. This suggests that the iron will be quickly stripped from the solid Kyanite material. Further, that the hydrochloric acid preferentially dissolves alumina over silica. Since the extract contains a weight ratio of Al₂O₃ to SiO₂ of between 11:1 and 12:1, and the source Kyanite has a weight ratio of about 1.4:1, the Kyanite-containing material would be expected to eventually become deficient in Al₂O₃ if the Kyanite-containing material were subject to a number of successive extractions.

Certain embodiments of this invention, as well as certain advantages of this invention, are illustrated by the preceding non-limiting examples. Although only a limited number of examples are disclosed herein, in the interests of brevity and clarity, it will be apparent to those skilled in the art that many modifications, both to materials and methods, may be practiced without departing from the purpose and interest of this invention.

1. A method for reducing the rate of deterioration of wood comprising the steps of:
A) providing an aqueous wood preservative composition comprising dissolved aluminum and dissolved and/or suspended silica, wherein the concentration of aluminum as alumina is between about 300 mg Al₂O₃/L and 20000 mg Al₂O₃/L and the concentration of aluminum as alumina is at least two times the concentration of silica, and
B) injecting the aqueous wood preservative composition into wood, wherein the pH of the injected wood preservative composition is below about 3.

2. The method of claim 1 wherein the aqueous wood preservative composition further comprises a biocide selected from a substantially insoluble organic biocide, a biocidal quaternary ammonium compound, or any combination thereof.

3. The method of claim 1 wherein the aqueous wood preservative composition further comprises a biocide selected from a salt of copper, a salt of zinc, a salt of nickel, a salt of tin, or any combination thereof.

4. The method of claim 1 wherein the aqueous wood preservative composition is substantially free of a biocide selected from a substantially insoluble organic biocide, a biocidal quaternary ammonium compound, a salt of copper, a salt of zinc, a salt of nickel, and a salt of tin.

5. The method of claim 1 wherein the concentration of dissolved and/or suspended silica in the aqueous wood preservative composition is between about 10 mg SiO₂/L and 6000 mg SiO₂/L, and the concentration of aluminum as alumina is at least three times the concentration of silica.

6. The method of claim 1 wherein the pH of the aqueous wood preservative composition is below about 2, and the dissolved aluminum (as alumina) is between about 4 times and 25 times the amount of dissolved and/or suspended silicon as silica.

7. The method of claim 1 wherein the aqueous wood preservative composition further comprises a dissolved and/or suspended iron compound in an amount between about 50 mg/L and 20000 mg/L as Fe₂O₃.

8. The method of claim 7 wherein the aqueous wood preservative composition further comprises a dissolved and/or suspended titanium compound in an amount between about 1 mg/L and 2000 mg/L as TiO₂.

9. The method of claim 1 wherein the aqueous wood preservative composition further comprises a dissolved and/or suspended titanium compound in an amount between about 1 mg/L and 2000 mg/L as TiO₂.

10. The method of claim 1 wherein the aqueous wood preservative composition comprises between about 0.1 moles to about 6 moles of acid per liter.

11. The method of claim 1 wherein the step of providing an aqueous wood preservative composition comprises the steps of 1) providing a wood preservative concentrate having a pH below about 1, and 2) diluting the wood preservative concentrate to provide the aqueous wood preservative composition.

12. The method of claim 1 wherein the step of providing an aqueous wood preservative composition comprises the step of contacting a solid mineral source comprising alumina and silica with an aqueous strongly acidic composition for a time and at a temperature sufficient to dissolve the aluminum, wherein there an excess of the solid mineral source so that there remains solid mineral source material after the contacting with acid.

13. The method of claim 12 wherein the solid mineral source comprises kyanite.

14. The method of claim 12 wherein the solid mineral source comprises one or more of kyanite, andalusite, sillimanite, alumina, mullite, Biotite, chloritoid, Fayalite, Titanite, Albite, Oligoclase, Andesine, Elbaite, Microcline, Anorthite, Orthoclase, Kaolin, Sanidine, magnesium aluminum silicate, calcium magnesium aluminum silicate, and smectite.

15. A method for reducing the rate of deterioration of wood comprising the steps of:
A) providing an aqueous wood preservative composition comprising dissolved aluminum and dissolved and/or suspended titanium, wherein the concentration of aluminum as alumina is between about 300 mg Al₂O₃/L and 20000 mg Al₂O₃/L and the concentration of aluminum as alumina is at least two times the concentration of titanium as titania, and
B) injecting the aqueous wood preservative composition into wood, wherein the pH of the injected wood preservative composition is below about 3.

16. The method of claim 15 wherein the aqueous wood preservative composition further comprises a biocide selected from a substantially insoluble organic biocide, a biocidal quaternary ammonium compound, or any combination thereof.

17. The method of claim 15 wherein the aqueous wood preservative composition further comprises a biocide selected from a salt of copper, a salt of zinc, a salt of nickel, a salt of tin, or any combination thereof.

18. The method of claim 15 wherein the aqueous wood preservative composition is substantially free of a biocide selected from a substantially insoluble organic biocide, a biocidal quaternary ammonium compound, a salt of copper, a salt of zinc, a salt of nickel, and a salt of tin.

19. The method of claim 15 wherein the pH of the aqueous wood preservative composition is below about 2, and the dissolved aluminum (as alumina) is between about 10 times and 200 times the amount of dissolved and/or suspended titanium as titania.

20. The method of claim 15 wherein the aqueous wood preservative composition further comprises a dissolved and/or suspended iron compound in an amount between about 50 mg/L and 20000 mg/L as Fe₂O₃.

21. The method of claim 15 wherein the aqueous wood preservative composition comprises between about 0.1 moles to about 6 moles of acid per liter.

22. The method of claim 15 wherein the step of providing an aqueous wood preservative composition comprises the steps of 1) providing a wood preservative concentrate having a pH below about 1, and 2) diluting the wood preservative concentrate to provide the aqueous wood preservative composition.

23. The method of claim 15 wherein the step of providing an aqueous wood preservative composition comprises the step of contacting a solid mineral source comprising alumina and titanium with an aqueous strongly acidic composition for a time and at a temperature sufficient to dissolve the aluminum, wherein there an excess of the solid mineral source so that there remains solid mineral source material after the contacting with acid.

24. A method for reducing the rate of deterioration of wood comprising the steps of:
A) providing an aqueous wood preservative composition comprising dissolved silicon and dissolved titanium, wherein the concentration of dissolved silicon as silica is between about 10 mg SiO₂/L and 6000 mg SiO₂/L and the concentration of silicon as silica is between 1 and about 50 times the concentration of titanium as titania, and
B) injecting the aqueous wood preservative composition into wood, wherein the pH of the injected wood preservative composition is below about 3.

25. The method of claim 24 wherein the aqueous wood preservative composition further comprises a biocide selected from a substantially insoluble organic biocide, a biocidal quaternary ammonium compound, a salt of copper, a salt of zinc, a salt of nickel, a salt of tin, or any combination thereof.

26. The method of claim 24 wherein the aqueous wood preservative composition is substantially free of a biocide selected from a substantially insoluble organic biocide, a biocidal quaternary ammonium compound, a salt of copper, a salt of zinc, a salt of nickel, and a salt of tin.

27. The method of claim 24 wherein the pH of the aqueous wood preservative composition is below about 2, and the amount of titanium as titania is between about 10 mg TiO₂/L and 2000 mg TiO₂/L.

28. The method of claim 24 wherein the aqueous wood preservative composition further comprises a dissolved and/or suspended iron compound in an amount between about 50 mg/L and 20000 mg/L as Fe₂O₃.

29. The method of claim 24 wherein the step of providing an aqueous wood preservative composition comprises the step of contacting a solid mineral source comprising silicon and titanium with an aqueous strongly acidic composition for a time and at a temperature sufficient to dissolve the silicon, wherein there an excess of the solid mineral source so that there remains solid mineral source material after the contacting with acid.

30. An aqueous wood preservative composition comprising: silicon in an amount between 20 mg/L and 6000 mg/L as SiO₂, titanium in an amount 1 mg/L and 2000 mg/L as TiO₂, and aluminum in an amount between 50 mg/L and 20000 mg/L as Al₂O₃, wherein the pH of the aqueous wood preservative composition is below 2.5.

31. The aqueous wood preservative composition of claim 30 further comprising iron in an amount between about 50 mg/L and 20000 mg/L as Fe₂O₃.

32. The aqueous wood preservative composition of claim 30 further comprising a substantially insoluble organic biocide, a biocidal quaternary ammonium compound, or both.

33. The aqueous wood preservative composition of claim 30 further comprising a salt of copper, a salt of zinc, a salt of nickel, a salt of tin, or any combination thereof.
